(19) United States
(12) Patent Application Publication
(10) Pub. No.: US 2015/0036976 A1
(43) Pub. Date: Feb. 5, 2015

(54) SOLAR CONCENTRATOR

(71) Applicant: Docter Optics SE, Neustadt an der Orla (DE)

(72) Inventors: Wolfram Wintzer, Jena (DE); Lars Arnold, Neustadt (DE); Hagen Goldammer, Jena (DE)

(21) Appl. No.: 14/378,077

(22) PCT Filed: Dec. 5, 2012
(86) PCT No.: PCT/EP2012/005009

§ 371 Date: Aug. 11, 2014

(30) Foreign Application Priority Data
Feb. 21, 2012 (DE) 10 2012 003 340.0

(51) Int. Cl. G02B 19/00; G02B 6/26

(52) U.S. Cl. CPC G02B 19/0004; G02B 19/0042; G02B 6/26
USPC 385/31

(57) ABSTRACT

The invention relates to a solar concentrator made of a transparent material, wherein the solar concentrator comprises a light incoupling surface that may be spherical or non-spherical, a light outcoupling surface, and a light guide component arranged between the light incoupling surface and the light outcoupling surface, the light guide component being delimited between the light incoupling surface and the light outcoupling surface by a light guide component surface.

### CROSS-REFERENCE TO RELATED APPLICATIONS

This is a U.S. nationalization under 35 U.S.C. §371 of International Application No. PCT/EP2012/005009, filed Dec. 5, 2012, which claims priority to German Application No. 10 2012 003 340.0, filed Feb. 21, 2012, the contents of which are hereby incorporated herein by reference.

### FIELD OF THE INVENTION

The invention concerns a solar concentrator made from transparent material, wherein the solar concentrator comprises a light entry face, a light exit face, and a light guide portion arranged between the light entry surface and the light exit surface (it should be noted that in context with the light entry and light exit areas described and outlined in the following specification and claims the term “face”, only, is used for the sake of simplicity and is to include the term and meaning of “surface”, as well) and tapering in the direction of the light exit face, which light guide portion is restricted by a light guide portion surface between the light entry face and the light exit face.

### BACKGROUND INFORMATION

PCT/EP2010/005755 (WO 20011/050886 A2) discloses a solar concentrator having a solid body made from transparent material, which comprises a light entry face and a light exit face, wherein the solid body comprises a light guide portion tapering in the direction of the light exit face between the light entry face and the light exit face, which light guide portion is restricted by a light guide portion surface between the light entry face and the light exit face, and wherein the light guide portion surface undergoes transition or merges into the light exit face with a continuous first derivative.

It is an object of the invention to reduce the costs for manufacturing solar concentrators and secondary solar concentrators, respectively. To this end, increasing the portion of unobjectionable and marketable pieces of manufacture is desirable.

### SUMMARY

The aforementioned object is achieved by a solar concentrator having a monolithic and solid body, respectively, from transparent material, which body comprises a light entry face and a light exit face, wherein the solid body comprises a light guide portion arranged between the light entry face and the light exit face and tapering (linearly or none-linearly) in the direction of the light exit face, which light guide portion is restricted by a light guide portion surface between the light entry face and the light exit face, and wherein the light guide portion surface comprises at least one indentation, groove or notch.

The transparent material is glass. The transparent material is silicate glass. The transparent material is glass as described in Document PCT/EP2008/010136. The glass comprises
0.2 to 2% by weight Al₂O₃,
0.1 to 1% by weight Li₂O,
0.3, in particular 0.4 to 1.5% by weight Sb₂O₃,
60 to 75% by weight SiO₂,
3 to 12% by weight Na₂O,
3 to 12% by weight K₂O, and/or
3 to 12% by weight CaO.

A light guide portion surface is inclined by at least 3° with respect to the optical axis of the solar concentrator. An optical axis of the solar concentrator is an orthogonal or the orthogonal, respectively, of the light exit face. The light guide portion surface may be coated.

In an embodiment the light guide portion surface merges, transits or undergoes transition into the light exit face with a continuous first derivative. In a further embodiment the light guide portion surface merges, transits or undergoes transition into the light exit face with a curvature (curve) whose radius is no more than 0.25 mm, in particular no more than 0.15 mm, preferably no more than 0.1 mm. In a further embodiment the radius of curvature is more than 0.04 mm. In a further advantageous embodiment the particularly curved transition from the light guide portion surface to the light exit face is blank-molded.

In a further embodiment the light exit face is blank-molded.

In a further embodiment the light entry face is convex or planar. The light entry face may be configured to be non-spherical or spherical.

In a further embodiment the light exit face is blank-molded. The term blank molding is to be understood in a manner that an optically operative surface is to be molded under pressure such that any subsequent finishing or post-treatment of the contour of this optically effective surface may be dispensed with and does not apply and will not have to be provided for, respectively. Consequently, it is provided for that, after blank—molding, the light exit face is not ground, i.e. it will not be treated by grinding.

In a further embodiment, the light exit face is (curved) convex(ly). In a further embodiment, the convex light exit face is curved with a curvature of more than 30 mm. In a further embodiment of the invention, the convex light exit face is curved such that its (maximum) deviation of contour from the ideal plane and the light exit plane, respectively, amounts to less than 100 μm. An ideal plane is a plane through the transition of the light guide passage portion surface into the light exit face. A light exit plane is a plane through the transition of the light guide passage portion surface into the light exit face. A light exit plane is, in particular, a plane parallel to the plane through the transition of the light passage guide portion surface into the light exit face, when said plane is located through the apex (of the curvature) of the light exit face. A light exit plane is a plane orthogonal to the tapering light guide (passage) portion when said plane is located through the apex (of the curvature) of the light exit face. A light exit plane is, in particular, a plane orthogonal to the optical axis of the solar concentrator when said plane is located through the apex (of the curvature) of the light exit face. In another embodiment of the invention, the convex light exit face is curved such that its (maximum) deviation of contour from the ideal plane and the light exit face, respectively, amounts to more than 1 μm, in particular more than 40 μm. In a further embodiment the light exit face is planar. A planar light exit face may show a deviation of contour with respect to an ideal plane particularly based on shrinkage and in particular being concave, which deviation may, for example, amount up to 20 μm or even up to 40 μm.

In an embodiment the solar concentrator comprises a support frame situated between the light entry face and the light exit face, which support frame includes an outer edge, which is, in particular totally, blank-molded. A support frame may well be a flange. A support frame may be configured to be totally or at least partially circumferential. An outer edge is that part of the solar concentrator which is situated at the farthest distance from the optical axis of the solar concentrator. An outer edge is that part of the solar concentrator which, when seen radially, has the largest extension. It has been provided for that the support frame extends at least partially beyond the light guide portion in an orthogonal direction relative to the axis of the solar concentrator and/or that the support frame at least partially protrudes beyond the light guide portion radially with respect to the optical axis of the solar concentrator.

In a further embodiment all surfaces of the solar concentrator are blank-molded.

In a further embodiment the light guide (passage) portion surface comprises at least two separate indentations. In a further embodiment the light guide (passage) portion surface comprises at least four separate indentations.

In a further embodiment the indentation/the indentations is/are arranged in that half of the light guide portion surface which is facing the light entry face. In a further embodiment the indentation/the indentations is/are exclusively arranged in that half of the light guide portion surface which is facing the light entry face. In a further embodiment the indentation/the indentations is/are (exclusively) arranged in that third of the light guide portion surface which is facing the light entry face.

In a further embodiment the indentation/the indentations expands/expand in the direction of the light guide portion surface.

In a further embodiment the indentation runs out into a support frame of the solar concentrator. In a further embodiment the light guide portion surface and the cross section thereof, respectively, have a point of inflexion in the region of the indentation and the edge thereof, respectively.

In a further embodiment the indentation/the indentations includes/include a continuously concavely curved cross section.

In a further embodiment the light guide portion merges, transits or undergoes transition into the support frame by means of a concavely curved transitional area. In a further embodiment the light guide portion surface undergoes transition into the support frame by means of a/the concavely curved transitional area. In a further embodiment the solid body comprises a concavely curved transitional area between the light guide portion and the support frame.

In a further embodiment the concave curvature of the transitional area is curved with a radius of curvature of at least 0.3 mm, in particular of at least 0.5 mm, in particular of at least 1 mm. In a further embodiment the concave curvature of the transitional area is curved with a radius of curvature of, at most, 20% of the extension of the light guide portion in the direction of the optical axis of the solar concentrator, in particular of 2 mm, at the utmost.

The aforementioned object is moreover achieved by a solar concentrator comprising, in particular, one or several of the aforementioned features and having a monolithic and solid body, respectively, from transparent material, which comprises a light entry face and a light exit face, wherein the solid body comprises a light guide portion arranged between the light entry face and the light exit face and, in particular, tapering (linearly or none—linearly) in the direction of the light exit face, which light guide portion is restricted by a light guide portion surface between the light entry face and the light exit face, wherein the solid body comprises a support frame situated between the light entry face and the light guide portion, and wherein the light guide portion merges, transits or undergoes transition into the support frame by means of a concavely curved (blank-molded) transitional area, the light guide portion surface merges, transits or undergoes transition into the support frame by means of a concavely curved (blank-molded) transitional area and/or the solid body comprises a concavely curved (blank-molded) transitional area between the light guide portion and the support frame.

In a further embodiment the concave curvature of the (blank-molded) transitional area is curved with a radius of curvature of at least 0.3 mm, in particular of at least 0.5 mm, in particular of at least 1 mm. In a further embodiment the concave curvature of the (blank-molded) transitional area is curved with a radius of curvature of, at most, 20% of the extension of the light guide portion in the direction of the optical axis of the solar concentrator, in particular of 2 mm, at the utmost.

The invention moreover concerns a solar module comprising an aforementioned solar concentrator made from transparent material, wherein the solar concentrator, with its convex light exit face, is connected to a photovoltaic element and/or facing a photovoltaic element. In a further embodiment the solar module comprises a heat sink on which the photovoltaic element is arranged. In a further embodiment a retention means for the solar concentrator is arranged on the heat sink. In a further embodiment of the solar module comprises a retention means for the solar concentrator. In a further embodiment the retention means fixes the solar concentrator to a support frame of the solar concentrator. In a further embodiment the solar module includes a lens for aligning sunlight onto the light entry face of the solar concentrator.

The disclosure moreover concerns a method for generating electric energy, wherein sunlight is made to enter the light entry face of a solar concentrator of an aforementioned solar module, in particular by means of a primary solar concentrator.

Further advantages and details will become apparent from the following description of examples of embodiments:

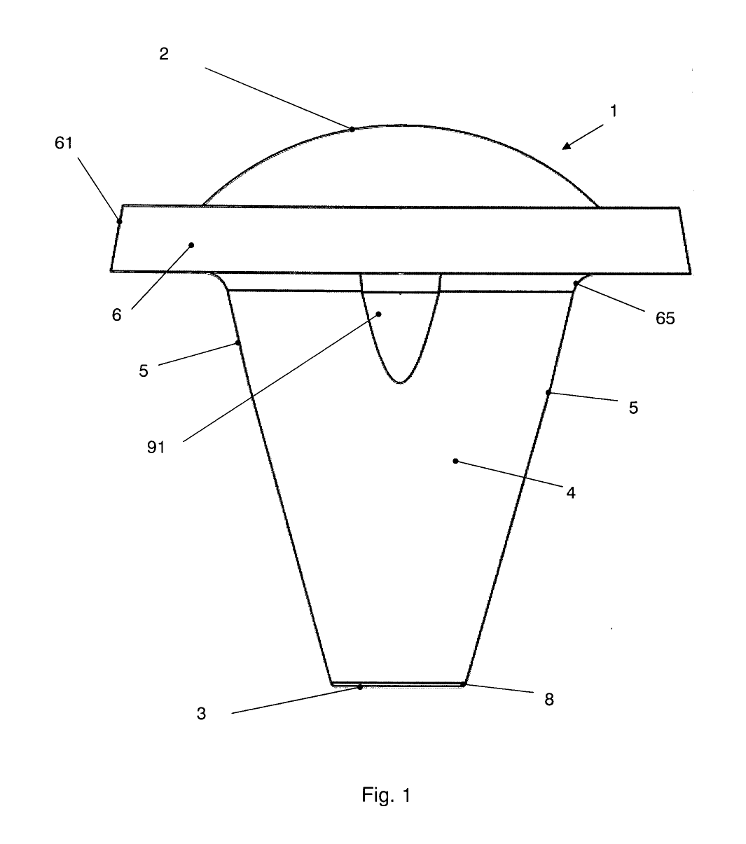

FIG. 1 shows an example of embodiment of a solar concentrator in accordance with the present invention;

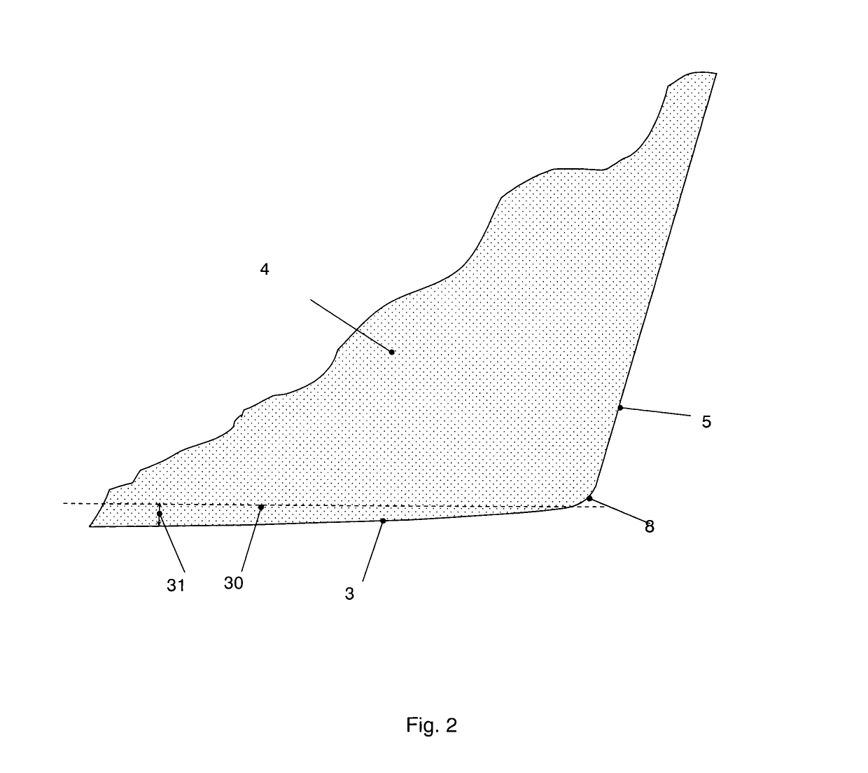

FIG. 2 shows a cut-out representation of the solar concentrator as shown in FIG. 1;

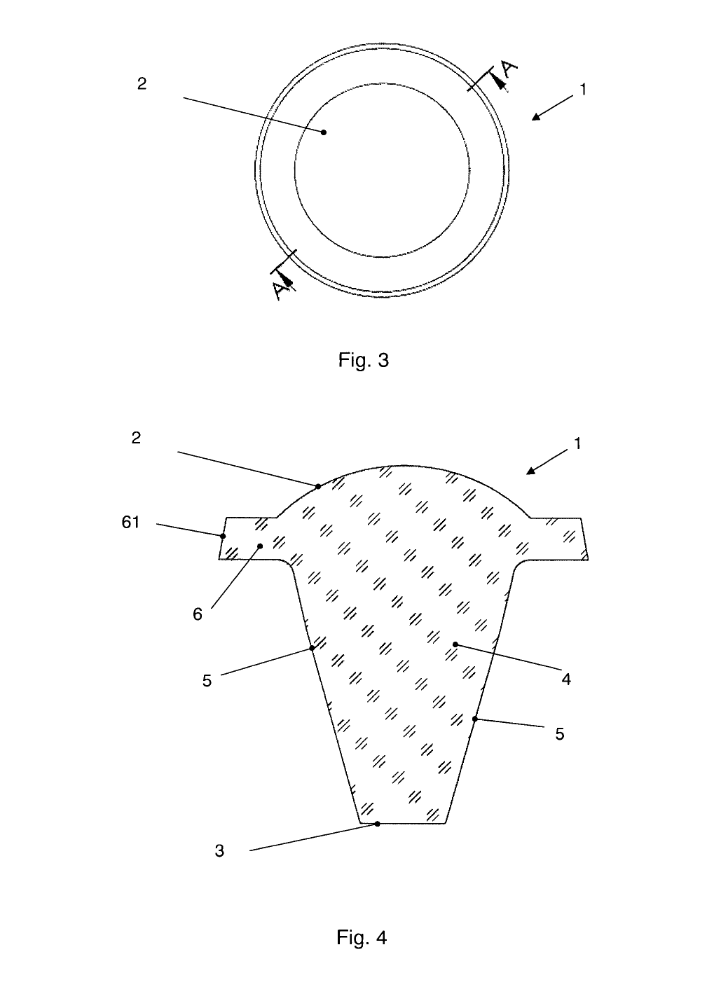

FIG. 3 shows a top view of the solar concentrator as shown in FIG. 1;

FIG. 4 shows the solar concentrator as shown in FIG. 1 by way of a sectional representation according to the section line A-A of FIG. 3;

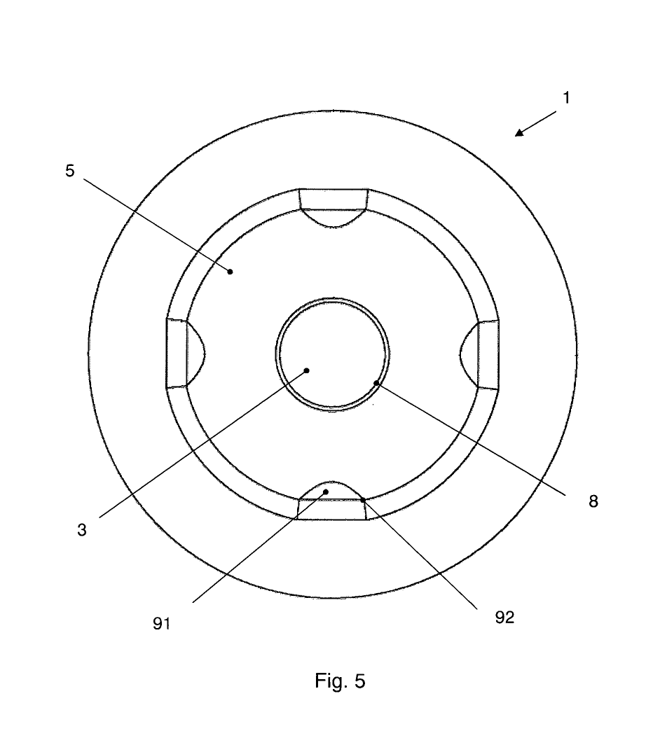

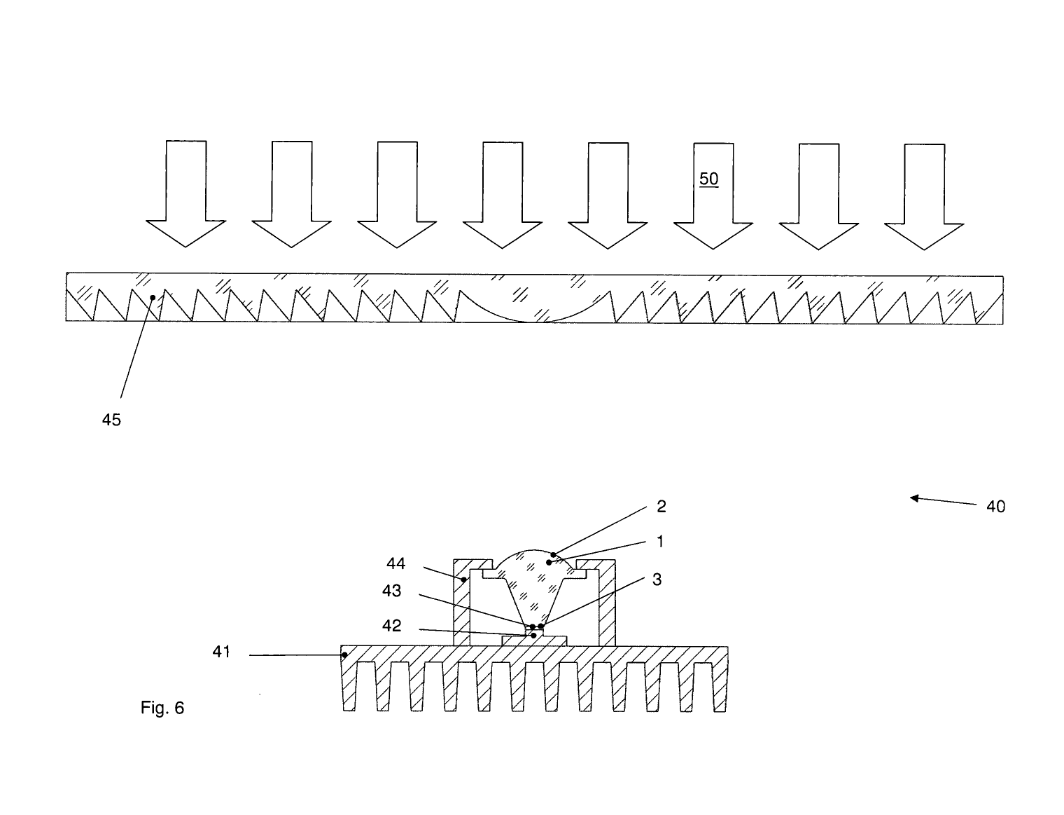

FIG. 5 shows the solar concentrator in accordance with FIG. 1 by way of a view from below; and

FIG. 6 shows an example of an embodiment of a solar module including a solar concentrator in accordance with FIG. 1.

### DETAILED DESCRIPTION

FIG. 1 shows, by way of a cross-sectional representation, an example of embodiment of a solar concentrator 1. The solar concentrator 1 comprises a light entry face 2 and a blank-molded light exit face 3 as well as a light guide (passage) portion 4 located between the light entry face 2 and the light exit face 3 and tapering in the direction of the light exit face 3. Reference numeral 5 designates a light guide portion surface which restricts the light guide portion 4 between the light entry face 2 and the light exit face 3. Herein, the light guide portion surface 5 merges (transits or undergoes transition)—as has been represented in greater detail in FIG. 2—into the light exit face 3 with a curvature 8 whose radius of curvature is approximately 0.1 mm. In an embodiment the convex light exit face 3 is curved with a radius of curvature of more than 30 mm and such, respectively, that the maximum of its deviation 31 of contour from the ideal plane and the light exit face 30, respectively, amounts to less than 100 μm. In the present example of embodiment the convex light exit face 3 is curved convexly such that the maximum of its contour deviation 31 from the ideal plane and the light exit face 30, respectively, amounts to less than 100 μm. Between the light entry face 2 and the light guide portion surface 5 the solar concentrator 1 includes a support frame 6 having a blank-molded outer edge 61, wherein the surface 5 is the light guide portion surface 5 undergoes transition into the support frame 5 (to read correctly: 6) by means of a concavely curved (blank-molded) transitional area 65 (radius of curvature=1.5 mm).

FIG. 3 shows a top view of the solar concentrator 1 and FIG. 4 shows the solar concentrator by way of a sectional representation according to the section line A-A of FIG. 3. FIG. 5 shows a view from below of the solar concentrator 1. The solar concentrator 1 includes, in the upper portion of the solar concentrator 1, a plurality of indentations 91 of the light guide portion surface 5. Herein, the indentations extend up to the support frame 6. The light guide portion surface 5 and its cross sectional curve, respectively, includes an inflexion point 92 in the region of the indentation 91.

FIG. 6 shows an example of embodiment of a solar module 40 including a solar concentrator 1 in accordance with the present invention. The solar module 40 comprises a heat sink or cooling body 41 on which a photovoltaic element 42 and retention means 44 for the solar concentrator 1 are arranged. The light exit face 3 is connected to the photovoltaic element 42 by means of a layer 43 of adhesive material. The solar module 40 furthermore comprises a primary solar concentrator 45 designed as a Fresnel lens or drum lens, for aligning sunlight 50 with respect to the light entry face 2 of the solar concentrator 1 arranged and configured and provided for, respectively, as a secondary solar concentrator. Sunlight fed into the solar concentrator 1 via the light entry face 2 exits via the light exit face 3 of the solar concentrator 1 and encounters the photovoltaic element 42.

1-17. (canceled)

18. A solar concentrator having a solid body from transparent material, the solid body comprising:
a light entry face;
a light exit face; and
a light guide portion arranged between the light entry face and the light exit face, the light guide portion being restricted by a light guide portion surface between the light entry face and the light exit face, wherein the light guide portion surface comprises at least one indentation.

19. A solar concentrator as claimed in claim 18, wherein the light guide portion surface comprises at least two separate indentations.

20. A solar concentrator as claimed in claim 19, wherein the indentations are arranged in that half of the light guide portion surface which is facing the light entry face.

21. A solar concentrator as claimed in claim 19, wherein the indentations are exclusively arranged in that half of the light guide portion surface which is facing the light entry face.

22. A solar concentrator as claimed in claim 19, wherein the indentations are arranged in that third of the light guide portion surface which is facing the light entry face.

23. A solar concentrator as claimed in claim 19, wherein the indentations expand in the direction of the light guide portion surface.

24. A solar concentrator as claimed in claim 19, wherein the indentations include a concavely curved cross section.

25. A solar concentrator as claimed in claim 18, wherein the light guide portion surface comprises at least four separate indentations.

26. A solar concentrator as claimed in claim 18, wherein the indentation is arranged in that half of the light guide portion surface which is facing the light entry face.

27. A solar concentrator as claimed in claim 18, wherein the indentation is exclusively arranged in that half of the light guide portion surface which is facing the light entry face.

28. A solar concentrator as claimed in claim 18, wherein the indentation is arranged in that third of the light guide portion surface which is facing the light entry face.

29. A solar concentrator as claimed in claim 18, wherein the indentation expands in the direction of the light guide portion surface.

30. A solar concentrator as claimed in claim 18, wherein the indentation includes a concavely curved cross section.

31. A solar concentrator as claimed in claim 18, wherein the light guide portion is tapering in the direction of the light exit face.

32. A solar concentrator as claimed in claim 31, the solid body further comprising:
a support frame situated between the light entry face and the light guide portion.

33. A solar concentrator as claimed in claim 32, wherein the light guide portion undergoes transition into the support frame by means of a concavely curved transitional area, the concave curvature of the transitional area being curved with a radius of curvature of at least 0.3 mm.

34. A solar concentrator as claimed in claim 18, the solid body further comprising:
a support frame situated between the light entry face and the light guide portion, wherein the light guide portion undergoes transition into the support frame by means of a concavely curved transitional area, the concave curvature of the transitional area being curved with a radius of curvature of at least 0.3 mm.

35. A solar concentrator as claimed in claim 34, wherein the concave curvature of the transitional area is curved with a radius of curvature of not more than 2 mm.

36. A solar concentrator having a solid body from transparent material, the solid body comprising:
a light entry face;
a light exit face;
a light guide portion tapering in the direction of the light exit face and being arranged between the light entry face and the light exit face, the light guide portion being restricted by a light guide portion surface between the light entry face and the light exit face; and
a support frame situated between the light entry face and the light guide portion, wherein the light guide portion surface undergoes transition into the support frame by means of a concavely curved transitional area the concave curvature of the transitional area being curved with a radius of curvature of at least 0.3 mm.

37. A solar concentrator as claimed in claim 36, wherein the concave curvature of the transitional area is curved with a radius of curvature of at least 0.5 mm.

38. A solar concentrator having a solid body from glass, the solid body comprising:
a light entry face;
a light exit face;
a light guide portion being arranged between the light entry face and the light exit face, the light guide portion being restricted by a light guide portion surface between the light entry face and the light exit face;
a support frame situated between the light entry face and the light guide portion; and
a concavely curved transitional area between the light guide portion and the support frame, wherein the concave curvature of the transitional area is curved with a radius of curvature of at least 0.3 mm and not more than 2 mm.
